(19) United States
(12) Patent Application Publication
(10) Pub. No.: US 2016/0328871 A1
(43) Pub. Date: Nov. 10, 2016

(54) GRAPHICS SYSTEM AND ASSOCIATED METHOD FOR DISPLAYING BLENDED IMAGE HAVING OVERLAY IMAGE LAYERS

(71) Applicant: MediaTek Inc., Hsin-Chu (TW)

(72) Inventor: Chiung-Fu CHEN, Hsinchu City (TW)

(21) Appl. No.: 15/137,418

(22) Filed: Apr. 25, 2016

Related U.S. Application Data
(60) Provisional application No. 62/157,066, filed on May 5, 2015.

(51) Int. Cl. G06T 11/60; G06T 1/20; G06T 1/60

(52) U.S. Cl. CPC G06T 11/60; G06T 1/60; G06T 1/20; G06T 2207/20221; G06T 2200/28; G06T 2207/20021

(57) ABSTRACT

A graphics system and an associated method for retrieving data in the graphics system to display a blended image composed of a plurality of overlay image layers are provided. The method includes the steps of: dividing each of the overlay image layers into a plurality of regions; obtaining respective transparency information of each region of the overlay image layers; and generating the blended image according to the respective transparency information of each region of the overlay image layers.

### CROSS REFERENCE TO RELATED APPLICATIONS

This application claims the benefit of U.S. Provisional Application No. 62/157,066, filed on May 5, 2015, the entirety of which is incorporated by reference herein.

### BACKGROUND OF THE INVENTION

1. Field of the Invention

The invention relates to graphics processing, and, in particular, to a graphics system and a method for retrieving data in a graphics system to display a blended image composed of a plurality of overlay image layers.

2. Description of the Related Art

Mobile devices on the market are usually equipped with graphics system such as a graphics processing unit for rendering and composing different overlay image layers. Conventionally, the graphics system also includes a compositor to generate a resulting blended image according to the overlay image layers. For example, the overlay image layers are usually arranged with different priorities, where the topmost overlay image layer has the highest priority, and the bottom overlay image layer has the lowest priority. However, a conventional compositor has to retrieve all pixels of the overlay image layers from the frame buffer when generating the resulting blended image, and thus a huge amount of memory bandwidth is required.

Accordingly, there is demand for a graphics system and an associated method for displaying a blended image composed of a plurality of overlay image layers to solve the aforementioned problem.

### BRIEF SUMMARY OF THE INVENTION

A detailed description is given in the following embodiments with reference to the accompanying drawings.

In an exemplary embodiment, a method for retrieving data in the graphics system to display a blended image composed of a plurality of overlay image layers is provided. The method includes the steps of: dividing each of the overlay image layers into a plurality of regions; obtaining respective transparency information of each region of the overlay image layers; and generating the blended image according to the respective transparency information of each region of the overlay image layers.

In another exemplary embodiment, a method for retrieving data in the graphics system to display a blended image composed of a plurality of overlay image layers is provided. The method includes the steps of: dividing each of the overlay image layers into a plurality of regions, each region including a plurality of pixels; storing respective pixel data associated with each pixel of the overlay image layers into at least one of one or more frame buffers of the graphics system; obtaining respective metadata associated with each region of the overlay image layers according to pixel data associated with the pixels of the region of the overlay image layer; storing the respective metadata associated with each region of the overlay image layers into at least one of the one or more frame buffers of the graphics system; retrieving the respective metadata of each region of the overlay image layers from the at least one of the one or more frame buffers; determining whether to retrieve or skip pixel data of each of the regions of the overlay image layers from the at least one of the one or more frame buffers respectively according to the retrieved metadata associated with the region; and generating the blended image according to the retrieved regions of the overlay image layers.

In yet another exemplary embodiment, a graphics system is provided. The graphics system includes a graphics processing unit (GPU) and a compositor. The graphics processing unit (GPU) is configured to divide each of the overlay image layers into a plurality of regions. The compositor is configured to obtain the respective transparency information of each region of the overlay image layers, and to generate the blended image according to the transparency information of each region of the overlay image layers.

In yet another exemplary embodiment, a graphics system is provided. The graphics system includes: one or more frame buffers; a graphics processing unit (GPU), and a compositor. The GPU is configured to divide each of the overlay image layers into a plurality of regions, wherein each region comprises a plurality of pixels, and the GPU further stores respective pixel data associated with each pixel of the overlay image layers into at least one of the one or more frame buffers of the graphics system, obtains respective metadata associated with each region of the overlay image layers according to pixel data associated with the pixels of the region of the overlay image layer, and stores the respective metadata associated with each region of the overlay image layers into at least one of the one or more frame buffers of the graphics system. The compositor is configured to retrieve the respective metadata of each region of the overlay image layers from the at least one of the one or more frame buffers, determine whether to retrieve or skip pixel data of each of the regions of the overlay image layers from the at least one of the one or more frame buffers respectively according to the retrieved metadata associated with the region, and generate the blended image according to the retrieved regions of the overlay image layers.

### BRIEF DESCRIPTION OF THE DRAWINGS

The invention can be more fully understood by reading the subsequent detailed description and examples with references made to the accompanying drawings, wherein:

FIG. 1 is a diagram of a graphics system in accordance with an embodiment of the invention;

FIG. 2A is a diagram of the overlay image layers and respective transparency information in accordance with an embodiment of the invention;

FIG. 2B is a diagram illustrating composition of the overlay image layers in accordance with an embodiment of the invention;

FIG. 3 is a flow chart of a method for retrieving data in a graphics system to display a blended image composed of a plurality of overlay image layers in accordance with an embodiment of the invention; and

FIG. 4 is a flow chart of a method for retrieving data in a graphics system to display a blended image composed of a plurality of overlay image layers in accordance with another embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

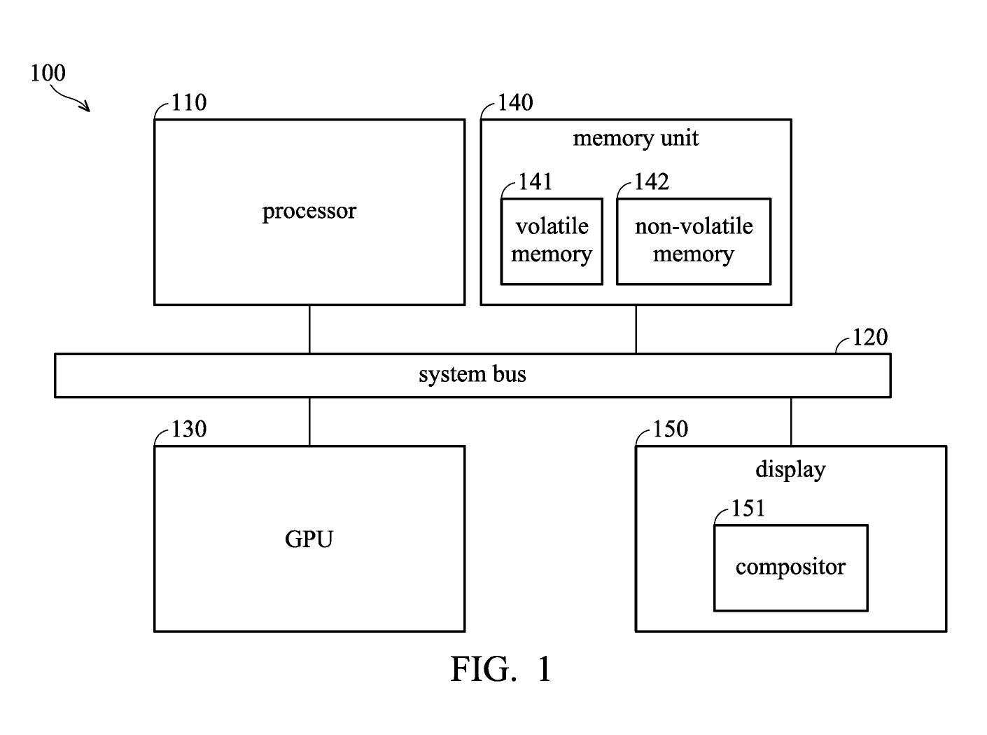

FIG. 1 is a diagram of a graphics system in accordance with an embodiment of the invention. The graphics system 100 can be a mobile device (e.g., a tablet computer, a smartphone, or a wearable computing device) or a laptop computer capable of acquiring images. The graphics system 100 can also be implemented as multiple chips or a single chip such as a system on chip (SOC) or a mobile processor disposed in a mobile device. For example, the graphics system 100 comprises a processor 110, a system bus 120, a graphics processing unit (GPU) 130, a memory unit 140, and a display 150. The processor 110, the GPU 130, and the memory unit 140 can be coupled to each other through the system bus 120. The processor 110 may be a central processing unit (CPU) general-purpose processor, a digital signal processor (DSP), or any equivalent circuitry, but the disclosure is not limited thereto. The memory unit 140, for example, may include a volatile memory 141 and a non-volatile memory 142. The volatile memory 141 may be a dynamic random access memory (DRAM) or a static random access memory (SRAM), and the non-volatile memory 142 may be a flash memory, a hard disk, a solid-state disk (SSD), etc. For example, the program codes of the applications for use on the graphics system 100 can be pre-stored in the non-volatile memory 142. The processor 110 may load program codes of applications from the non-volatile memory 142 to the volatile memory 141, and execute the program code of the applications. The processor 110 may also transmit the graphics data to the GPU 130, and the GPU 130 may determine the graphics data to be rendered on the display 150 (the details will be described later). It is noted that although the volatile memory 141 and the non-volatile memory 142 are illustrated as a memory unit, they can be implemented separately as different memory units. In addition, different numbers of volatile memory 141 and/or non-volatile memory 142 can be also implemented in different embodiments. The display 150 can be a display circuit or hardware that can be coupled for controlling a display device (not shown). The display device may include either or both of a driving circuit and a display panel and can be disposed internal or external to the graphics system 100.

In an embodiment, the display 150 may comprise a compositor 151. In some other embodiments, the compositor 151 is a stand-alone circuit that is external to the display 150. The compositor 151 can be configured to generate a resulting blended image or a frame according to the graphics data such as a plurality of overlay image layers. For example, each of the overlay image layers is divided into a plurality of regions, and each region has respective transparency information (e.g. alpha value) that is assigned by either of the processor 110 and the GPU 130 or both. The divided regions can be equally-sized tiles or blocks or non-equally-sized tiles or blocks. Each overlay image layer can be divided in the same way. In addition, the overlay image layers to be rendered can be stored in the memory unit 140, e.g., in the volatile memory 141. The compositor 151 may obtain the respective transparency information of each region of the overlay image layers from the volatile memory 141, and generate the blended image according to the transparency information of each region of the overlay image layers. Due to implementation considerations, the overlay image layers can be stored in a first frame buffer, and the respective transparency information can be stored in a second frame buffer.

In an embodiment, each of the overlay image layers are divided into a plurality of regions, and each region of the overlay image layer also includes a plurality of pixels. Respective pixel data associated with each pixel of the overlay image layers can be stored in one or more frame buffers of the graphics system. In some embodiments, each region in the overlay image layers has its own metadata, and the respective metadata associated with each region of the overlay image layers can be obtained according to the pixel data associated with the pixels of the region of the overlay image layers.

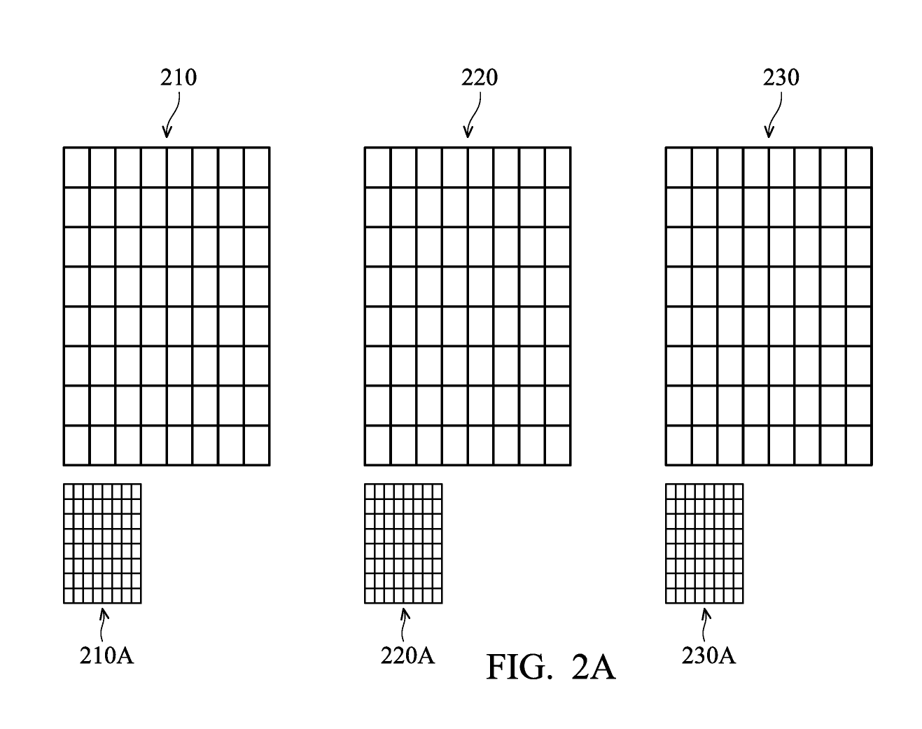

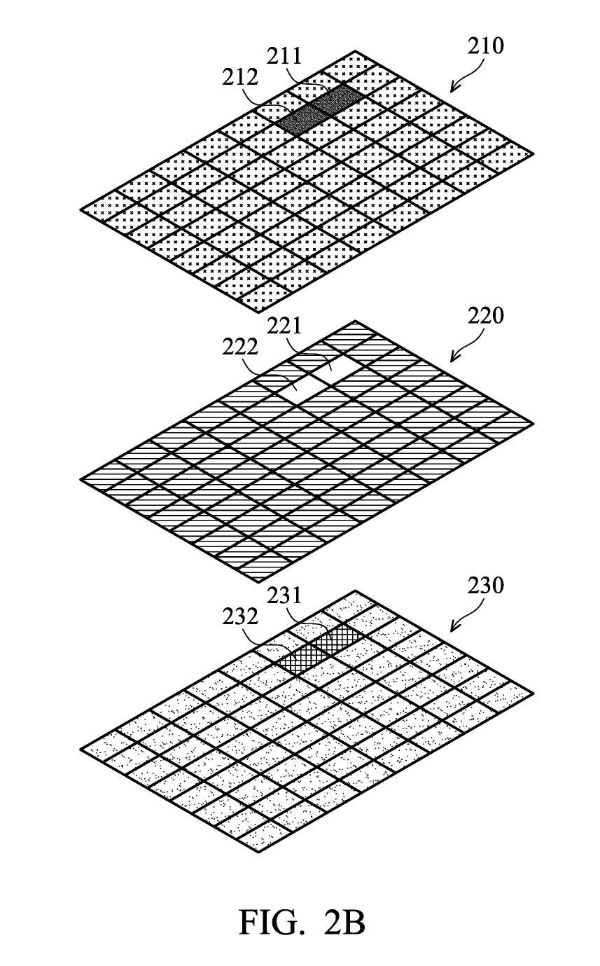

In some embodiments, the respective metadata of each region of the overlay image layers may comprise transparency information of each region of the overlay image layers. In other words, the pixel data associated with a specific pixel/region may include the pixel value(s) of the specific pixel/region. In addition, the pixel data associated with the specific pixel/region may further include or be stored along with the transparency information associated with the specific pixel or region. As will be illustrated more below with embodiments shown in connection with FIG. 2B, when the transparency information of any region of any overlay image layer in the overlay image layers indicates a transparent region, the compositor skips retrieving pixel values of the transparent region of the overlay image layer.

In some other embodiments, the respective metadata of each region of the overlay image layers may comprise respective dirtiness information associated with each region of the overlay image layers. When the dirtiness information of any region of any overlay image layer in the overlay image layers indicates a non-dirty region, the compositor can skip retrieving pixel values of the non-dirty region of the overlay image layer. Specifically, when the dirtiness information associated with a certain region of the overlay image layers of a current frame indicates that the pixels in the region are dirty, it indicates that the pixel values associated with the certain region for the current frame are different from the pixel values associated with the same region for a previous frame (frames at an earlier time). Accordingly, the pixel values associated with the certain region for the certain frame are required to be retrieved to update the display 150. In contrast, when the dirtiness information associated with a certain region of the overlay image layers of a current frame indicates that the pixels in the region are non-dirty, it indicates that the pixel values associated with the certain region for the certain frame are the same as the pixel values associated with the same region for a previous. Accordingly, it is not necessary or it can be skipped to retrieve the pixel values associated with the certain region for the current frame.

It is also noted that in some further other embodiments, multiple types of information can be stored as the metadata for each region of the overlay image layers. For example, the respective metadata of the specific region may record both transparency information and dirtiness information of the specific region and/or other type(s) of information. In one embodiment, it can be determined whether to retrieve data values for any region in any overlay image layers for a current frame first by using dirtiness information and then using transparency information.

In addition, the metadata associated with each region of the overlay image layers can be stored in one or more frame buffers of the graphics system 100. For example, the volatile memory 141 may include a plurality of partitions, and each partition can be regarded as a frame buffer, and the respective metadata associated with each region of the overlay image layers can be stored in one or more frame buffers of the graphics system 100. The frame buffers storing the metadata of each region of the overlay image layers can be the same as those storing the pixel data of each region of the overlay image layers. Alternatively, the frame buffers storing the metadata of each region of the overlay image layers can also be different from those storing the pixel data of each region of the overlay image layers.

It should be noted that the compositor 151 may determine whether to retrieve or skip pixel data of each region of the overlay image layers from the respective frame buffers according to the retrieved metadata associated with each region of the overlay image layers. In an embodiment where the respective metadata of each region of the overlay image layer comprises respective transparency information associated with each region of the overlay image layers, when the transparency information of a specific region in the overlay image layers indicates a transparent region, the compositor 151 may skip data access of the specific region in the overlay image layers. In contrast, when the transparency information of a specific region in the overlay image layers indicates a non-transparent region, the compositor 151 may retrieve data of the specific region in the overlay image layers. In the same or different embodiment where the respective metadata of each region of the overlay image layer comprises respective dirtiness information associated with each region of the overlay image layers, when the metadata of a specific region in the overlay image layers indicates a non-dirty region, the compositor 151 may skip data access of the specific region in the overlay image layers. In contrast, when the dirtiness information of a specific region in the overlay image layers indicates a dirty region, the compositor 151 may retrieve data of the specific region in the overlay image layers.

FIG. 2A is a diagram of the overlay image layers and respective transparency information in accordance with an embodiment of the invention. For example, there are 3 overlay image layers such as the image layer 210, image layer 220, and image layer 230. The image layer 210 is the topmost overlay image layer, and the image layer 230 is the bottom overlay image layer. The overlay image layers 210, 220, and 230 can be stored in the volatile memory 141 (i.e. a frame buffer) as well as their respective transparency information 210A, 220A and 230A of each region for example. Specifically, the transparency information of each region in the image layer 210 is recorded as data 210A. Similarly, the transparency information of each region in the image layers 220 and 230 are recorded as data 220A and 230A, as shown in FIG. 2A. For the purposes of description, the number of overlay image layers is 3 in the aforementioned embodiment. One having ordinary skill in the art will appreciate that a different number of overlay image layers can be used in the compositor 151 of the display 150.

FIG. 2B is a diagram illustrating composition of the overlay image layers in accordance with an embodiment of the invention. In an embodiment, before the compositor 151 generates the blended image, the compositor 151 may obtain the transparency information 210A, 220A and 230A from the volatile memory 141, and determine whether to access the regions of each overlay image layer from the volatile memory 141 according to the transparency information of each region in the overlay image layers.

In an example case, given that the regions 211 and 212 of the overlay image layer 210 are opaque and the transparency information (e.g. alpha value) of the regions 211 and 212 is 1, it indicates that the transparency settings of the regions 211 and 212 of the topmost overlay image layer 210 may fully overwrite the transparency settings of the co-located regions (e.g. regions 221, 222, 231, and 232) of the overlay image layers 220 and 230 that are directly under the overlay image layer 210. Accordingly, the compositor 151 may skip data access of the regions 221, 222, 231 and 232 from the volatile memory 141 in generating the blended image, so that the required memory bandwidth can be reduced. Alternatively, the compositor 151 may also skip data access of the rows crossing the co-location of the specific respective region (e.g. regions 221 and 222 of the overlay image layer 220, and regions 231 and 232 of the overlay image layer 230) in the overlay image layers (e.g. overlay image layers 220 and 230) under the overlay image layer 210.

In another example case, when a specific region is the topmost opaque region among the co-located regions in the overlay image layers, the co-located regions directly under the specific region can be skipped by the compositor 151. For example, given that the regions 211 and 212 of the overlay image layer 210 are translucent regions (e.g. alpha value is between 0 and 1), the compositor 151 should access data of the regions 211 and 212 in generating the blended image. Further, the regions 221 and 222 of the overlay image layer 220 are opaque regions, and the regions 221 and 222 are also the topmost opaque regions among the co-located regions in the overlay image layers 220, and 230. Accordingly, the compositor 151 can skip data access of the regions 231 and 232 of the overlay image layer 230 that are directly under the opaque regions 221 and 222 while generating the blended image. Alternatively, the compositor 151 may also skip data access of the rows crossing the specific respective region (e.g. regions 221 and 222) in the overlay image layers (e.g. overlay image layer 230) under the overlay image layer 220.

In yet another example case, given that the region 211 of the overlay image layer 210 is a transparent region, it indicates that the image content of the region 211 can be allowed not to be rendered on the resulting blended image. The compositor 151 may therefore skip the data access of the region 211 while generating the blended image.

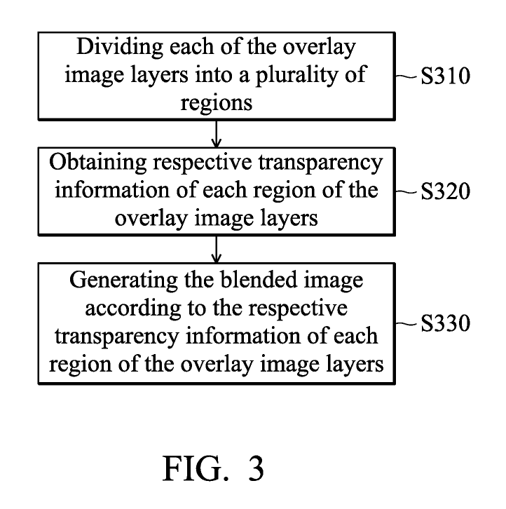

FIG. 3 is a flow chart of a method for retrieving data in a graphics system to display a blended image composed of a plurality of overlay image layers in accordance with an embodiment of the invention. In step S310, each of the overlay image layers are divided into a plurality of regions. In one embodiment, the regions in each overlay image layer can be equally-sized tiles or blocks. In another embodiment, the regions in each overlay image layer can be unequally-sized tiles or blocks. In step S320, respective transparency information of each region of the overlay image layers are obtained. It should be noted that the respective transparency information of each region of the overlay image layers can be stored in the frame buffer as those where the pixel values of the overlay image layers are stored, or it can be stored in another frame buffer different from the frame buffer storing the pixel values of the overlay image layers. It should also be noted that in step S330, the blended image is generated according to the transparency information of each region of the overlay image layers. More details about each step can be referred to embodiments in connection to FIGS. 1, 2 and 3 but not limited thereto. Moreover, the steps can be performed in different sequences and/or can be combined or separated in different embodiments.

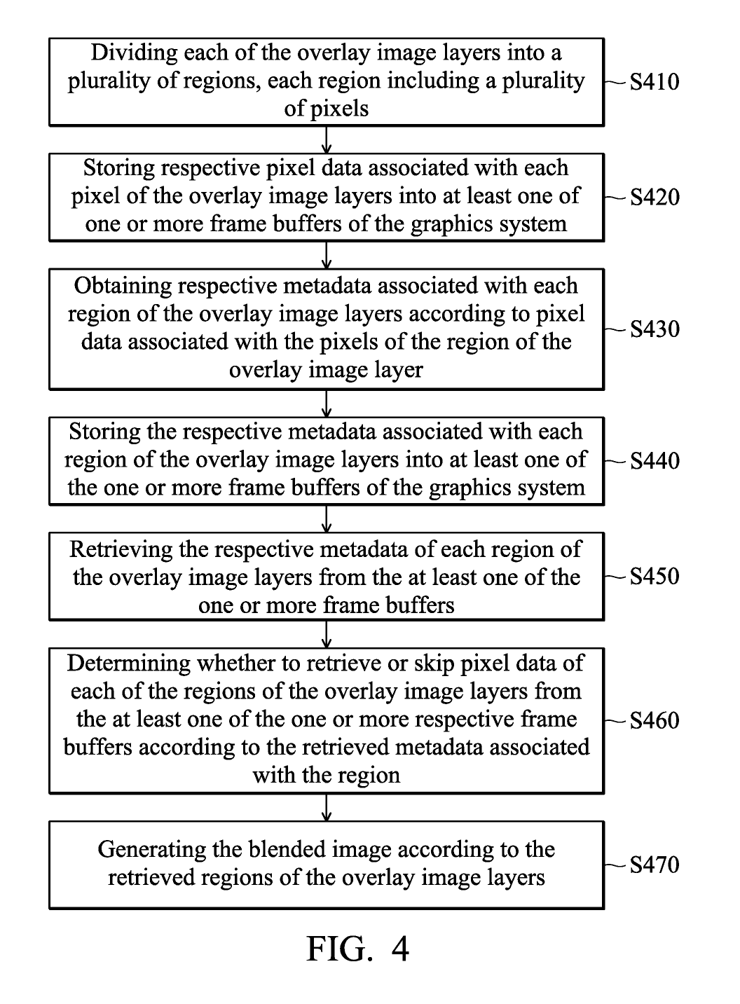

FIG. 4 is a flow chart of a method for retrieving data in a graphics system to display a blended image composed of a plurality of overlay image layers in accordance with another embodiment of the invention. The graphics system 100 of FIG. 1 is utilized here for explanation of the flow chart, which however, is not limited to be applied to the graphics system 100 only. In step S410, each of the overlay image layers is divided into a plurality of regions, where each region can include a plurality of pixels. The step S410 may be performed by GPU 130 in FIG. 1, for example.

In step S420, respective pixel data associated with each pixel of the overlay image layers are stored in at least one of one or more frame buffers of the graphics system 100. It should be noted that the aforementioned pixel data may include the pixel value of the pixel. The step S420 may be performed by GPU 130 in FIG. 1, for example.

In step S430, the respective metadata associated with each region of the overlay image layers is obtained according to the pixel data associated with the pixels in each region of the overlay image layer. The step S430 may be performed by GPU 130 in FIG. 1, for example.

In step S440, the respective metadata associated with each region of the overlay image layers are stored into at least one of the one or more frame buffers of the graphics system 100. It should be noted that the respective metadata associated with each region of the overlay image layers can be stored into the same frame buffer, or into different frame buffers. The step S440 may be performed by GPU 130 in FIG. 1, for example.

In step S450, the respective metadata of each region of the overlay image layers are retrieved from the at least one of the one or more frame buffers. The step S450 may be performed by the compositor 151 in FIG. 1, for example.

In step S460, it is determined whether to retrieve or skip the pixel data of each region of the overlay image layers from the at least one of the one or more frame buffers according to the retrieved metadata associated with each region of the overlay image layers. The step S460 may be performed by the compositor 151 in FIG. 1, for example. For example, in an embodiment where the respective metadata of a specific region includes dirtiness information, when the dirtiness information indicates a dirty region, the compositor 151 retrieves the data of the specific region from the one or more frame buffers. Conversely, when the dirtiness information indicates a non-dirty region, the compositor 151 can skip data access of the specific region from the one or more frame buffers.

In another or the same embodiment, the respective metadata of a specific region includes transparency information. When the transparency information indicates a totally non-transparent or opaque region for a certain overlay image layer, the compositor 151 may skip the retrieving the data of the specific region from the one or more frame buffers for other overlay image layer(s) beneath the certain overlay image layer. In addition, when the transparency information indicates a transparent region for any overlay image layer, the compositor 151 can skip data access of the specific region for the overlay image layer from the one or more frame buffers.

In step S470, the blended image is generated according to the retrieved regions of the overlay image layers. The step S470 may be performed by the compositor 151 in FIG. 1, for example. More details about each step can be referred to embodiments in connection to FIGS. 1, 2 and 3 but not limited thereto. Moreover, the steps can be performed in different sequences and/or can be combined or separated in different embodiments.

In view of the above embodiments, a graphics system and an associated method for displaying a blended image composed of a plurality of overlay image layers are provided. The compositor of the graphics system may retrieve respective metadata or transparency information of each region of the overlay image layers before accessing pixel data of each region of the overlay image layers, and determine which region should be retrieved from the frame buffers and which region can be skipped. For example, when a specific region is a transparent region, the compositor can skip data access of the specific region. When a specific region of a first overlay image layer is an opaque region, the co-located regions of the specific region in the other overlay image layers directly under the first overlay image layer can be skipped by the compositor. Accordingly, the number of data accesses to the frame buffer can be significantly reduced, and thus the required memory bandwidth can be reduced.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for retrieving data in a graphics system to display a blended image composed of a plurality of overlay image layers, comprising:
dividing each of the overlay image layers into a plurality of regions;
obtaining respective transparency information of each region of the overlay image layers; and
generating the blended image according to the respective transparency information of each region of the overlay image layers.

2. The method as claimed in claim 1, wherein the transparency information indicates an alpha value of each region.

3. The method as claimed in claim 1, further comprising:
when the transparency information of a specific region of a first overlay image layer in the overlay image layers indicates an opaque region, skipping one or more regions of one or more other overlay image layers under the specific region of the first overlay image layer.

4. The method as claimed in claim 3, wherein the specific region of the first overlay image layer is a topmost opaque region of the regions at the same location as the specific region in all of the image layers.

5. The method as claimed in claim 3, further comprising:
skipping one or more rows crossing the specific respective region in the one or more other overlay image layers under the first overlay image layer.

6. The method as claimed in claim 1, further comprising:
when the transparency information of the specific region of a first overlay image layer in the overlay image layers indicates a transparent region, skipping the specific region of the first overlay image layer.

7. The method as claimed in claim 1, further comprising:
storing the overlay image layers into at least one of one or more frame buffers of the graphics system;
storing the respective transparency information of each region of the overlay image layers into at least one of the one or more frame buffers of the graphics system.

8. The method as claimed in claim 7, wherein the generating the blended image according to the transparency information of each region of the overlay image layers comprises:
retrieving the respective transparency information of each region of the overlay image layers from the at least one of the one or more frame buffers;
determining whether to retrieve or skip the regions of the overlay image layers from the at least one of the one or more frame buffers according to the retrieved transparency information; and
generating the blended image according to the retrieved regions of the overlay image layers.

9. The method as claimed in claim 1, wherein the regions are equally-sized tiles or blocks.

10. A method for retrieving data in a graphics system to display a blended image composed of a plurality of overlay image layers, comprising:
dividing each of the overlay image layers into a plurality of regions, each region including a plurality of pixels;
storing respective pixel data associated with each pixel of the overlay image layers into at least one of one or more frame buffers of the graphics system;
obtaining respective metadata associated with each region of the overlay image layers according to pixel data associated with the pixels of the region of the overlay image layer;
storing the respective metadata associated with each region of the overlay image layers into at least one of the one or more frame buffers of the graphics system;
retrieving the respective metadata of each region of the overlay image layers from the at least one of the one or more frame buffers;
determining whether to retrieve or skip pixel data of each of the regions of the overlay image layers from the at least one of the one or more respective frame buffers according to the retrieved metadata associated with the region; and
generating the blended image according to the retrieved regions of the overlay image layers.

11. The method as claimed in claim 10, wherein the respective metadata of each region of the overlay image layer comprises respective transparency information associated with the region of the overlay image layer.

12. The method as claimed in claim 11, wherein the determining whether to retrieve or skip pixel data of each of the regions of the overlay image layers from the at least one of the one or more respective frame buffers according to the retrieved metadata associated with the region comprises:
when the transparency information of a specific region of a first overlay image layer in the overlay image layers indicates an opaque region, skipping one or more regions of one or more other overlay image layers under the specific region of the first overlay image layer.

13. The method as claimed in claim 11, wherein the determining whether to retrieve or skip pixel data of each of the regions of the overlay image layers from the at least one of the one or more respective frame buffers according to the retrieved metadata associated with the region comprises:
when the transparency information of any region of any overlay image layer in the overlay image layers indicates a transparent region, skipping the transparent region of the overlay image layer.

14. The method as claimed in claim 10, wherein the respective metadata of each region of the overlay image layer comprises respective dirtiness information associated with the region of the overlay image layer.

15. The method as claimed in claim 14, wherein the determining whether to retrieve or skip pixel data of each of the regions of the overlay image layers from the at least one of the one or more respective frame buffers according to the retrieved metadata associated with the region comprises:
when the dirtiness information of any region of any overlay image layer in the overlay image layers indicates a non-dirty region, skipping retrieving of the non-dirty region of the overlay image layer.

16. A graphics system for displaying a blended image composed of a plurality of overlay image layers, comprising:
a graphics processing unit (GPU), configured to divide each of the overlay image layers into a plurality of regions; and
a compositor, configured to obtain respective transparency information of each region of the overlay image layers, and generate the blended image according to the transparency information of each region of the overlay image layers.

17. The graphics system as claimed in claim 16, wherein the transparency information indicates an alpha value of each region.

18. The graphics system as claimed in claim 16, wherein when the transparency information of a specific region of a first overlay image layer in the overlay image layers indicates an opaque region, the compositor skips retrieving of one or more regions of one or more other overlay image layers under the specific region of the first overlay image layer.

19. The graphics system as claimed in claim 18, wherein the specific region of the first overlay image layer is a topmost opaque region of the regions at the same location as the specific region in all of the image layers.

20. The graphics system as claimed in claim 18, wherein the compositor skips retrieving of one or more rows crossing the specific region respectively in the one or more other overlay image layers under the first overlay image layer.

21. The graphics system as claimed in claim 16, wherein when the transparency information of the specific region of a first overlay image layer in the overlay image layers indicates a transparent region, the compositor skips the specific region of the first overlay image layer.

22. The graphics system as claimed in claim 16, further comprising:
one or more frame buffers, wherein the GPU stores the overlay image layers into at least one of one or more frame buffers of the graphics system, and stores the respective transparency information of each region of the overlay image layers into at least one of the one or more frame buffers of the graphics system.

23. The graphics system as claimed in claim 22, wherein when generating the blended image according to the transparency information of each region of the overlay image layers, the compositor further retrieves the respective transparency information of each region of the overlay image layers from the at least one of the one or more frame buffers, determines whether to retrieve or skip the regions of the overlay image layers from the at least one of the one or more frame buffers according to the retrieved transparency information, and generates the blended image according to the retrieved regions of the overlay image layers.

24. The graphics system as claimed in claim 16, wherein the regions are equally-sized tiles or blocks.

25. A graphics system for displaying a blended image composed of a plurality of overlay image layers, comprising:
one or more frame buffers;
a graphics processing unit (GPU), configured to divide each of the overlay image layers into a plurality of regions, wherein each region comprises a plurality of pixels, and the GPU further stores respective pixel data associated with each pixel of the overlay image layers into at least one of the one or more frame buffers of the graphics system, obtains respective metadata associated with each region of the overlay image layers according to pixel data associated with the pixels of the region of the overlay image layer, and stores the respective metadata associated with each region of the overlay image layers into at least one of the one or more frame buffers of the graphics system; and
a compositor, configured to retrieve the respective metadata of each region of the overlay image layers from the at least one of the one or more frame buffers, determine whether to retrieve or skip pixel data of each of the regions of the overlay image layers from the at least one of the one or more frame buffers respectively according to the retrieved metadata associated with the region, and generate the blended image according to the retrieved regions of the overlay image layers.

26. The graphics system as claimed in claim 25, wherein the respective metadata of each region of the overlay image layer comprises respective transparency information associated with the region of the overlay image layer.

27. The graphics system as claimed in claim 26, wherein when the transparency information of a specific region of a first overlay image layer in the overlay image layers indicates an opaque region, the compositor skips retrieving of one or more regions of one or more other overlay image layers under the specific region of the first overlay image layer.

28. The graphics system as claimed in claim 26, wherein when the transparency information of any region of any overlay image layer in the overlay image layers indicates a transparent region, the compositor skips retrieving of the transparent region of the overlay image layer.

29. The graphics system as claimed in claim 25, wherein the respective metadata of each region of the overlay image layer comprises respective dirtiness information associated with the region of the overlay image layer.

30. The graphics system as claimed in claim 29, wherein when the dirtiness information of any region of any overlay image layer in the overlay image layers indicates a non-dirty region, the compositor skips retrieving of the non-dirty region of the overlay image layer.
